(19) United States
(12) Patent Application Publication
(10) Pub. No.: US 2019/0235608 A1
(43) Pub. Date: Aug. 1, 2019

(54) ELECTRONIC DEVICE INCLUDING CASE DEVICE

(71) Applicant: Samsung Electronics Co., Ltd., Gyeonggi-do (KR)

(72) Inventors: Eung Seo SHIN, Seoul (KR); Chul Min LEE, Gyeonggi-do (KR)

(21) Appl. No.: 16/339,036

(22) PCT Filed: Sep. 20, 2017
(86) PCT No.: PCT/KR2017/010307

§ 371 Date: Apr. 3, 2019

(30) Foreign Application Priority Data
Oct. 7, 2016 (KR) 10-2016-0129856

(51) Int. Cl. G06F 1/3234; G06F 1/16; A45C 11/00

(52) U.S. Cl. CPC G06F 1/3265; G06F 1/1605; A45C 2011/003; G06F 1/1616; G06F 1/1662; A45C 11/00

(57) ABSTRACT

An electronic device includes at least one magnet, a display, a terminal receiving a signal associated with the at least one magnet from a case device, an illuminance sensor, and a processor. The processor is configured to control ON/OFF of the display based on the signal transmitted from the terminal and brightness of light sensed by the illuminance sensor.

### TECHNICAL FIELD

Embodiments disclosed in the disclosure relate to a technology for controlling ON/OFF of a display.

### BACKGROUND ART

With the development of mobile communication technologies, an electronic device, which is equipped with a display, such as a tablet computer, a smartphone, a wearable device, or the like has been widely supplied. The electronic device may include several components to provide a user with various functions. For example, the electronic device may execute various functions such as a photo or video capturing function, a music or video file playing function, a game function, an Internet function, and the like through the display.

In addition, such the electronic device may be implemented in a portable form. For example, because the electronic device can supply power to several components using a battery, the user may carry an electronic device.

### DISCLOSURE

### Technical Problem

When a battery supplies power to a display, the display may be turned on. The amount of power supplied to the display among the various parts included in an electronic device may be relatively great as compared to those of other parts. Because the amount of power supplied to the display is relatively great compared to other parts, the battery consumption may increase when the display is turned on unnecessarily. Accordingly, when the display is turned on unnecessarily, the usable time may be reduced.

Embodiments disclosed in this specification may provide an electronic device for solving the above-described problem and problems brought up in this specification.

### Technical Solution

According to an embodiment disclosed in the disclosure, an electronic device may include at least one magnet, a display, a terminal receiving a signal associated with the at least one magnet from a case device, an illuminance sensor, and a processor. The processor may be configured to control ON/OFF of the display based on the signal transmitted from the terminal and brightness of light sensed by the illuminance sensor.

According to an embodiment disclosed in the disclosure, an electronic device including a case device may include at least one magnet, a first terminal receiving a signal associated with the magnet from the case device, a display, an illuminance sensor, and a processor. The case device may include an integrated circuit (IC) detecting a magnetic field generated by the at least one magnet and to generate the signal associated with the magnet and a second terminal electrically connected to the first terminal of the electronic device and transmitting the signal associated with the magnet from the case device to the electronic device. The processor of the electronic device may be configured to control ON/OFF of the display based on the signal associated with the magnet obtained via the first terminal and an illumination value sensed by the illuminance sensor.

According to an embodiment disclosed in the disclosure, a case device may include a first cover, a second cover at least partly overlapping with the first cover, a magnet disposed on the first cover, and an IC disposed on the second cover and configured to transmit a signal associated with the magnet to a tablet device.

### Advantageous Effects

According to various embodiments of the disclosure, it is possible to arrange an integrated circuit in the case device and it is possible to control ON/OFF of a display based on the magnitude of a magnetic field detected by the integrated circuit, thereby reducing unnecessary battery consumption.

According to various embodiments of the disclosure, it is possible to control ON/OFF of a display based on the brightness of light input to an illuminance sensor, thereby reducing unnecessary battery consumption.

Besides, a variety of effects directly or indirectly understood through this disclosure may be provided.

### DESCRIPTION OF DRAWINGS

FIG. 1 illustrates a case device and an electronic device, according to an embodiment.

FIG. 2 illustrates a perspective view of a case device, according to an embodiment.

FIG. 3 illustrates the electronic device in a network environment, according to an embodiment.

FIG. 4 illustrates an operation flowchart of an electronic device including a case device, according to an embodiment.

FIG. 5A illustrates an operation flowchart of an electronic device including a case device in the case where a case device is closed, when a display is turned on, according to an embodiment.

FIG. 5B illustrates an operation flowchart of an electronic device including a case device in the case where a case device is opened, when a display is turned off, according to an embodiment.

FIG. 6 illustrates an operation flowchart of an electronic device including a case device that controls ON/OFF of a display, based on brightness of light input to a display, according to an embodiment.

FIG. 7 illustrates a case device that is folded such that an electronic device is exposed to the outside, according to an embodiment.

FIG. 8 is a view in which an edge of an electronic device is placed on a keyboard, according to an embodiment.

FIG. 9 illustrates a block diagram of the electronic device according to an embodiment.

FIG. 10 illustrates a block diagram of a program module according to an embodiment.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar components may be marked by similar reference numerals.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing from the scope of the disclosure, a first component may be referred to as a second component, and similarly, a second component may be referred to as a first component.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when an component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

An electronic device according to various embodiments of the disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automated teller machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the disclosure may not be limited to the above-described electronic devices and may include other electronic devices and new electronic devices according to the development of technologies.

Hereinafter, electronic devices according to various embodiments will be described with reference to the accompanying drawings. In the disclosure, the term “user” may refer to a person who uses an electronic device or may refer to a device (e.g., an artificial intelligence electronic device) that uses the electronic device.

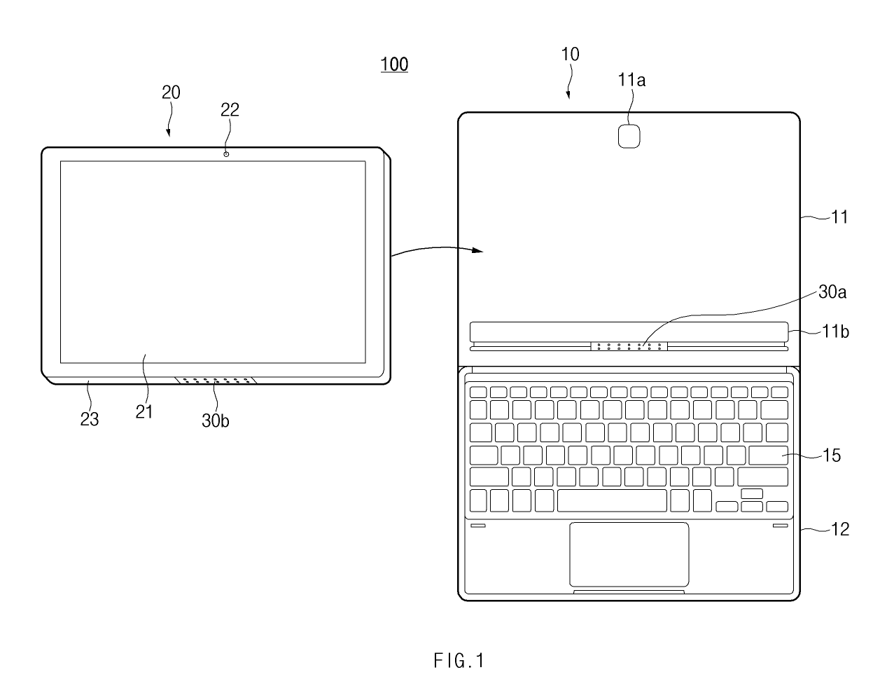

FIG. 1 illustrates a case device 10 and an electronic device 20, according to an embodiment.

Referring to FIG. 1, an electronic device 100 including a case device may include the case device 10 and the electronic device 20.

The case device 10 may include a first cover 11, a second cover 12, and a second terminal 30a. The first cover 11 may be a cover coupled to the rear housing of the electronic device 20. An opening 11a of a shape corresponding to the camera of the electronic device 20 may be positioned in the first cover 11. Furthermore, a coupling part llb that fixes the electronic device 20 by coupling the electronic device 20 may be positioned in the first cover 11.

The second cover 12 may be a cover that is connected to the first cover 11 and at least partly overlaps with the first cover 11. When the electronic device 20 is coupled to the first cover 11, the second cover 12 may be in contact with a display 21 of the electronic device 20. According to an embodiment of the disclosure, the second cover 12 may include a keyboard 15 disposed on the second cover 12. A user may enter data (e.g., character) into the electronic device 20 via the keyboard 15. The data entered via the keyboard 15 may be output via the display 21 of the electronic device 20.

An embodiment is exemplified in FIG. 1 as the case device 10 includes the first cover 11 and the second cover 12. However, the case device 10 may be composed of a single cover. For example, the case device 10 may be composed of only the second cover 12, and the case device 10 may be connected to the electronic device 20 via the second terminal 30a (e.g., POGO terminal).

The electronic device 20 may be a portable computer disposed on the first cover 11. When the electronic device 20 is disposed on the first cover 11, the electronic device 20 may be positioned between the first cover 11 and the second cover 12. Each of the first cover 11 and the second cover 12 may be formed of a shock absorbing material (e.g., emboss). When the first cover 11 and the second cover 12 are formed of the material, the first cover 11 and the second cover 12 may protect the electronic device 20 from external impact. Unlike the illustration of FIG. 1, in an embodiment where the case device 10 is composed of only the second cover 12, the electronic device 20 may be directly connected to the second cover 12.

The electronic device 20 may include the display 21, an illuminance sensor 22, and a first terminal 30b. The display 21 is disposed on the front side of the electronic device 20 to output an image. The display 21 may receive a user input (e.g., user's touch) via a cover glass disposed on the display 21. The illuminance sensor 22 may sense the brightness of light (or the illumination value) input to the illuminance sensor 22. The illuminance sensor 22 may be interposed between the display 21 and rear housing; as illustrated in FIG. 1, the illuminance sensor 22 may be disposed at a bezel. According to an embodiment of the disclosure, the electronic device may include a camera. The camera may detect the brightness of light input to the camera and may be disposed adjacent to the illuminance sensor.

The first terminal 30b (e.g., POGO terminal) may electrically connect the case device 10 to the electronic device 20. For example, the first terminal 30b and the second terminal 30a may be connected to each other. When the case device 10 is connected to the electronic device 20 via the first terminal 30b, the case device 10 and the electronic device 20 may exchange a signal (e.g., a signal associated with a magnet) with each other. As illustrated in FIG. 1, the first terminal 30b may be positioned at an edge 23 of the electronic device 20. The location of the first terminal 30b is not limited to the location illustrated in FIG. 1, and is formed at a location different from the location illustrated in FIG. 1.

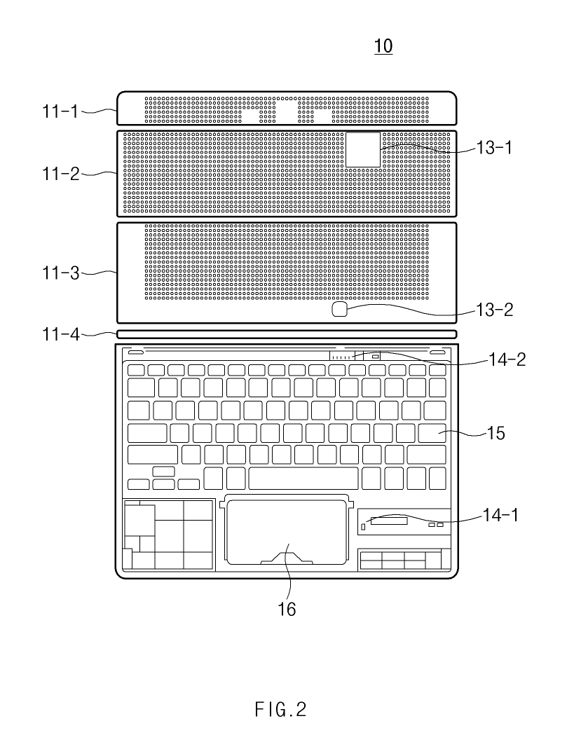

FIG. 2 illustrates a perspective view of the case device 10, according to an embodiment.

Referring to FIG. 2, the case device 10 may include magnets 13-1 and 13-2 and integrated circuits 14-1 and 14-2. The magnets 13-1 and 13-2 may be disposed within the first cover 11 and may be disposed on the surface of the first cover 11. When the first cover 11 is divided into a plurality of blocks, the magnets 13-1 and 13-2 may be disposed at one of a plurality of blocks. Moreover, as illustrated in FIG. 2, the magnets 13-1 and 13-2 may be disposed in a block 11-2 and a block 11-3. When the number of magnets is not less than two, the sizes of the magnets may be the same as one another or may be different from one another.

The integrated circuits (e.g., Hall IC) 14-1 and 14-2 may be disposed at the second cover 12. According to an embodiment of the disclosure, when the second cover 12 overlaps with the first cover 11, the integrated circuits 14-1 and 14-2 may be disposed at the locations corresponding to the magnets 13-1 and 13-2. For example, the integrated circuit 14-1 may be disposed next to the keyboard 15 and a keypad 16 to correspond to the magnet 13-1 disposed in the block 11-2. The integrated circuit 14-2 may be interposed between the keyboard 15 and a block 11-4 to correspond to the magnet 13-2 disposed in the block 11-3.

The integrated circuits 14-1 and 14-2 may generate a magnet-related signal that occurs in the magnets 13-1 and 13-2. For example, when the distance between the first cover 11 and the second cover 12 decreases, because the distance between the integrated circuits 14-1 and 14-2 and the magnets 13-1 and 13-2 decreases, the strength of a magnetic field may be stronger. When the strength of a magnetic field becomes stronger, the integrated circuits 14-1 and 14-2 may detect the strength of a magnetic field generated by the magnets 13-1 and 13-2 to generate the magnet-related signal, or vice versa.

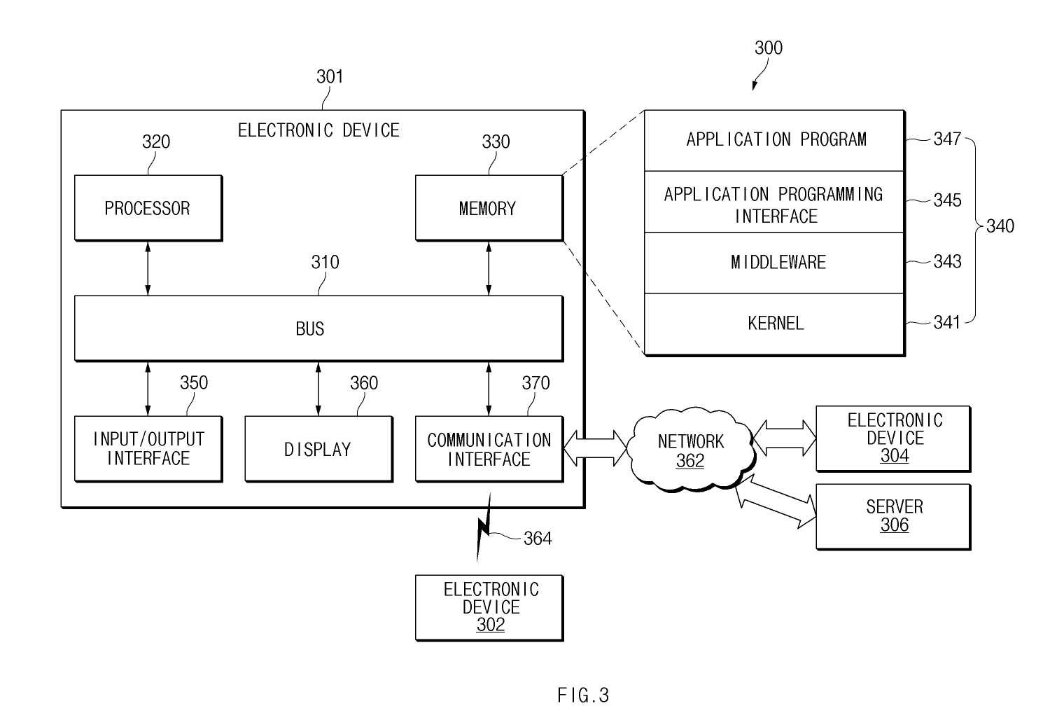

FIG. 3 illustrates an electronic device in a network environment, according to an embodiment. An electronic device 301 illustrated in FIG. 3 may correspond to the electronic device 20 illustrated in FIG. 1.

Referring to FIG. 3, according to various embodiments, an electronic device 301, a first electronic device 302, a second electronic device 304, or a server 306 may be connected each other over a network 362 or a short range communication 364. The electronic device 301 may include a bus 310, a processor 320, a memory 330, an input/output interface 350, a display 360, and a communication interface 370. According to an embodiment, the electronic device 301 may not include at least one of the above-described components or may further include other component(s).

For example, the bus 310 may interconnect the above-described components 310 to 370 and may include a circuit for conveying communications (e.g., a control message and/or data) among the above-described components.

The processor 320 may include one or more of a central processing unit (CPU), an application processor (AP), or a communication processor (CP).

For example, the processor 320 may perform an arithmetic operation or data processing associated with control and/or communication of at least other components of the electronic device 301. Furthermore, the processor 320 may receive a signal associated with a magnet to control ON/OFF of the display 360.

The memory 330 may include a volatile and/or nonvolatile memory. For example, the memory 330 may store commands or data associated with at least one other component(s) of the electronic device 301. According to an embodiment, the memory 330 may store software and/or a program 340. The program 340 may include, for example, a kernel 341, a middleware 343, an application programming interface (API) 345, and/or an application program (or “an application”) 347. At least a part of the kernel 341, the middleware 343, or the API 345 may be referred to as an “operating system (OS)”.

For example, the kernel 341 may control or manage system resources (e.g., the bus 310, the processor 320, the memory 330, and the like) that are used to execute operations or functions of other programs (e.g., the middleware 343, the API 345, and the application program 347). Furthermore, the kernel 341 may provide an interface that allows the middleware 343, the API 345, or the application program 347 to access discrete components of the electronic device 301 so as to control or manage system resources.

The middleware 343 may perform, for example, a mediation role such that the API 345 or the application program 347 communicates with the kernel 341 to exchange data.

Furthermore, the middleware 343 may process task requests received from the application program 347 according to a priority. For example, the middleware 343 may assign the priority, which makes it possible to use a system resource (e.g., the bus 310, the processor 320, the memory 330, or the like) of the electronic device 301, to at least one of the application program 347. For example, the middleware 343 may process the one or more task requests according to the priority assigned to the at least one, which makes it possible to perform scheduling or load balancing on the one or more task requests.

The API 345 may be, for example, an interface through which the application program 347 controls a function provided by the kernel 341 or the middleware 343, and may include, for example, at least one interface or function (e.g., an instruction) for a file control, a window control, image processing, a character control, or the like.

The input/output interface 350 may play a role, for example, of an interface which transmits a command or data input from a user or another external device, to other component(s) of the electronic device 301. Furthermore, the input/output interface 350 may output a command or data, received from other component(s) of the electronic device 301, to a user or another external device.

The display 360 may include, for example, a liquid crystal display (LCD), a light-emitting diode (LED) display, an organic LED (OLED) display, a microelectromechanical systems (MEMS) display, or an electronic paper display. The display 360 may display, for example, various contents (e.g., a text, an image, a video, an icon, a symbol, and the like) to a user. The display 360 may include a touch screen and may receive, for example, a touch, gesture, proximity, or hovering input using an electronic pen or a part of a user's body. The display 360 illustrated in FIG. 3 may correspond to the display 21 illustrated in FIG. 1.

For example, the communication interface 370 may establish communication between the electronic device 301 and an external device (e.g., the first electronic device 302, the second electronic device 304, or the server 306). For example, the communication interface 370 may be connected to the network 362 over wireless communication or wired communication to communicate with the external device (e.g., the second electronic device 304 or the server 306). The communication interface 370 illustrated in FIG. 3 may correspond to the terminal 30 illustrated in FIG. 1.

The wireless communication may use at least one of, for example, long-term evolution (LTE), LTE Advanced (LTE-A), Code Division Multiple Access (CDMA), Wideband CDMA (WCDMA), Universal Mobile Telecommunications System (UNITS), Wireless Broadband (WiBro), Global System for Mobile Communications (GSM), or the like, as cellular communication protocol. Furthermore, the wireless communication may include, for example, the short range communication 364. The short range communication 364 may include at least one of wireless fidelity (Wi-Fi), Bluetooth, near field communication (NFC), magnetic stripe transmission (MST), a global navigation satellite system (GNSS), or the like.

The MST may generate a pulse in response to transmission data using an electromagnetic signal, and the pulse may generate a magnetic field signal. The electronic device 301 may transfer the magnetic field signal to point of sale (POS), and the POS may detect the magnetic field signal using a MST reader. The POS may recover the data by converting the detected magnetic field signal to an electrical signal.

The GNSS may include at least one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”) based on an available region, a bandwidth, or the like. Hereinafter, in the disclosure, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 362 may include at least one of telecommunications networks, for example, a computer network (e.g., LAN or WAN), an Internet, or a telephone network.

Each of the first and second electronic devices 302 and 304 may be a device of which the type is different from or the same as that of the electronic device 301. According to an embodiment, the server 306 may include a group of one or more servers. According to various embodiments, all or a portion of operations that the electronic device 301 will perform may be executed by another or plural electronic devices (e.g., the first electronic device 302, the second electronic device 304 or the server 306). According to an embodiment, in the case where the electronic device 301 executes any function or service automatically or in response to a request, the electronic device 301 may not perform the function or the service internally, but, alternatively additionally, it may request at least a portion of a function associated with the electronic device 301 from another device (e.g., the electronic device 302 or 304 or the server 306). The other electronic device may execute the requested function or additional function and may transmit the execution result to the electronic device 301. The electronic device 301 may provide the requested function or service using the received result or may additionally process the received result to provide the requested function or service. To this end, for example, cloud computing, distributed computing, or client-server computing may be used.

According to an embodiment of the disclosure, the electronic device 301 may include the magnets 13-1 and 13-2 (refer to FIG. 2). When the magnets 13-1 and 13-2 are included in the electronic device 301 and the electronic device 301 is connected to the second cover 11 (refer to FIG. 1), the integrated circuits 14-1 and 14-2, (refer to FIG. 2) may detect the magnetic fields of the magnets 13-1 and 13-2 included in the electronic device 301. The integrated circuits 14-1 and 14-2 may generate a magnet-related signal, and the processor 320 may control ON/OFF of the display 360 based on the signal.

In an embodiment, the signal may include information about the magnitude and direction of the magnetic field. However, in another embodiment, the signal may indicate whether the electronic device 20 is closed by the case device 10. For example, when the strength of the magnetic field detected by the magnets 13-1 and 13-2 is greater than a specific magnitude (or not less than a first threshold value), the integrated circuits 14-1 and 14-2 may transmit a first signal (e.g., 1) to the electronic device 20; otherwise (or less than the second threshold value, which is less than or equal to the first threshold value), the integrated circuits 14-1 and 14-2 may transmit a second signal (e.g., 0) to the electronic device 20.

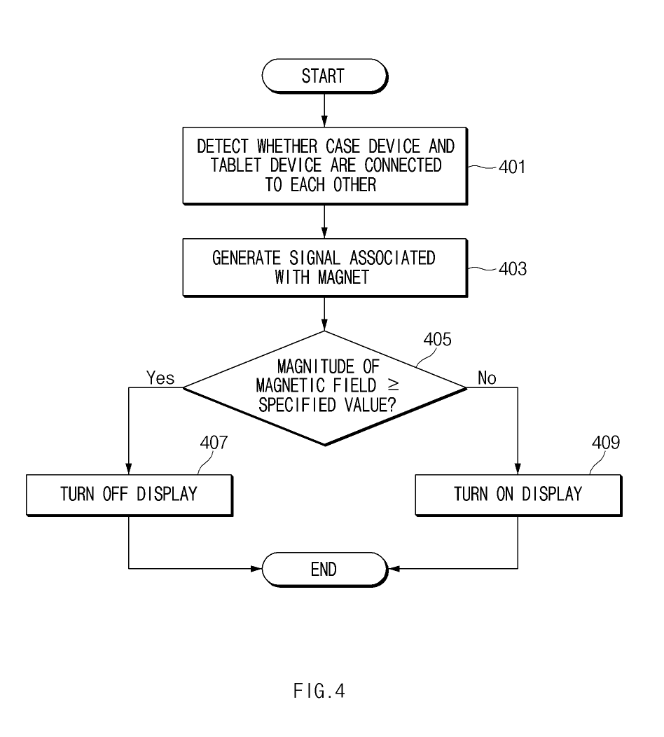

FIG. 4 illustrates an operation flowchart of the electronic device 100 including a case device, according to an embodiment.

In the disclosure, a description given with reference to FIGS. 1 to 3 may be identically applied to components that have the same reference marks as the case device 10, the electronic device 20, and the electronic device 301 described with reference to FIGS. 1 to 3. Furthermore, in the disclosure, the state where the case device 10 is closed may mean a state where the electronic device 20 is disposed on the first cover 11 and the display 360 is in contact with the second cover 12 or a state where the display 360 is located at a location adjacent to the second cover 12. A state where the case device 10 is opened may mean a state where the electronic device 20 is disposed on the first cover 11 and the display 360 is spaced apart from the second cover 12 by a predetermined distance.

In an embodiment in which the case device 10 includes only the second cover 12, the state where the case device 10 is closed may mean a state where the electronic device 10 is connected the second cover 12 and the display 360 is in contact with the second cover 12 or a state where the display 360 is located at a location adjacent to the second cover 12. The state where the case device 10 is opened may mean a state where the electronic device 10 is connected to the second cover 12 and the display 360 is spaced apart from the second cover 12 by a predetermined distance.

Referring to FIG. 4, in operation 401, the processor 320 may detect whether the case device 10 and the electronic device 20 are connected to each other. For example, the case device 10 and the electronic device 20 may be connected to each other via the terminal 30. When the case device 10 and the electronic device 20 are connected to each other, in operation 403, the integrated circuits 14-1 and 14-2 may generate a signal associated with a magnet generated by the magnets 13-1 and 13-2. The signal may be transmitted to the electronic device 20 via the terminal 30. The signal may include information about the magnitude and direction of the magnetic field.

When the signal is transmitted via the terminal 30, in operation 405, the processor 320 may compare the magnitude of the magnetic field with a specified value. The magnitude of the magnetic field may be inversely proportional to the distance between the magnets 13-1 and 13-2 and the integrated circuits 14-1 and 14-2. For example, when the distance between the magnets 13-1 and 13-2 and the integrated circuits 14-1 and 14-2 decreases, the magnitude of the magnetic field may increase; when the distance between the magnets 13-1 and 13-2 and the integrated circuits 14-1 and 14-2 increases, the magnitude of the magnetic field may decrease.

When the comparison result between the magnitude of the magnetic field and the specified value indicates that the magnitude of the magnetic field is not less than the specified value, in operation 407, the processor 320 may turn off the display 360. For example, when the user closes the case device 10, the distance between the magnets 13-1 and 13-2 disposed on the first cover 11 and the integrated circuits 14-1 and 14-2 disposed on the second cover 12 may decrease. When the distance between the magnets 13-1 and 13-2 and the integrated circuits 14-1 and 14-2 decreases, because the magnitude of the magnetic field may increase, the processor 320 may turn off the display 360.

When the comparison result between the magnitude of the magnetic field and the specified value indicates that the magnitude of the magnetic field is less than the specified value, in operation 409, the processor 320 may turn on the display 360. For example, when the user opens the case device 10, the distance between the magnets 13-1 and 13-2 disposed on the first cover 11 and the integrated circuits 14-1 and 14-2 disposed on the second cover 12 may increase. When the distance between the magnets 13-1 and 13-2 and the integrated circuits 14-1 and 14-2 increases, because the magnitude of the magnetic field may decrease, the processor 320 may turn on the display 360.

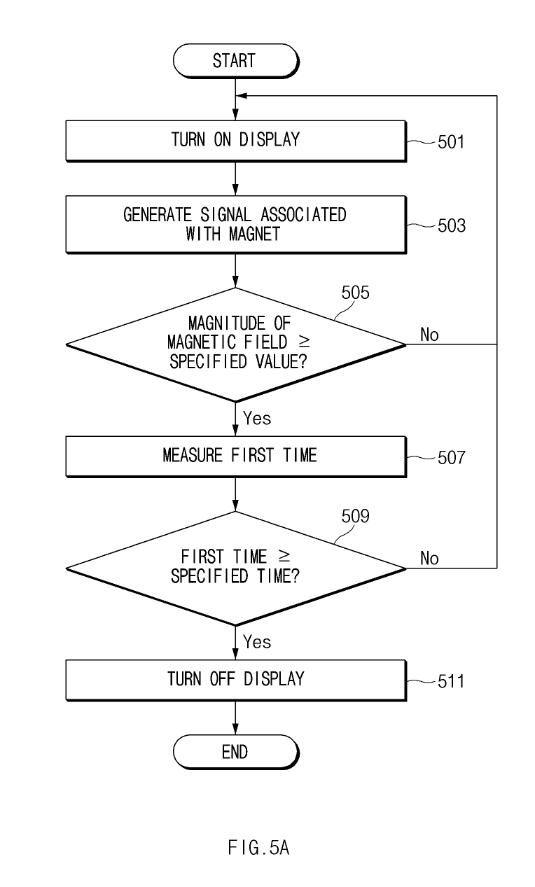

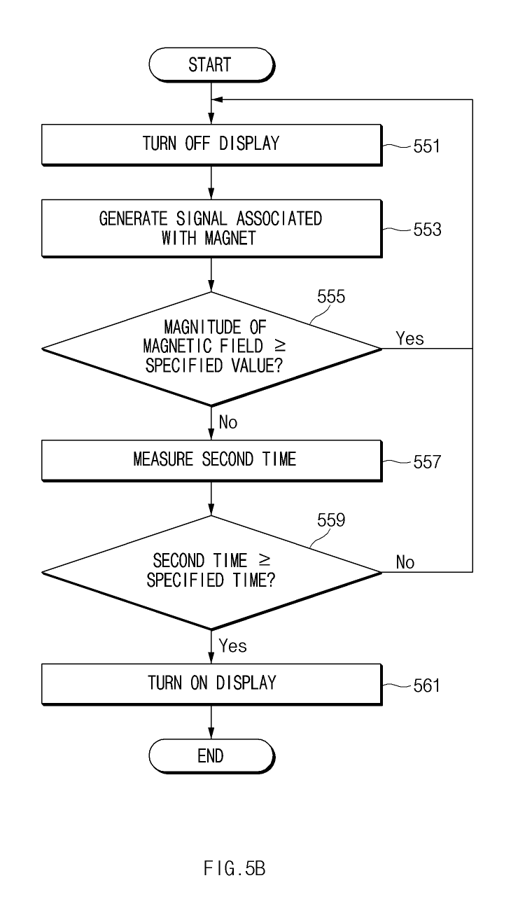

FIG. 5A illustrates an operation flowchart of the electronic device 100 including a case device in the case where the case device 10 is closed, when the display 360 is turned on, according to an embodiment.

Referring to FIG. 5A, in operation 501, the display 360 may be in an ON state. For example, when the case device 10 is opened in operation 501, the processor 320 may turn on the display 360. When the display 360 is in the ON state, the magnitude of a magnetic field may be less than a specified value.

In operation 503, the integrated circuits 14-1 and 14-2 may generate a magnet-related signal. When the signal is generated, the integrated circuits 14-1 and 14-2 may transmit the signal to the processor 320 via the terminal 30. When the signal is transmitted to the processor 320, in operation 505, the processor 320 may determine whether the magnitude of the magnetic field is not less than a specified value. When the determination result indicates that the magnitude of the magnetic field is less than the specified value, the processor 320 may allow the display 360 to remain in the ON state. For example, when remaining in a state where the case device 10 is opened, the processor 320 may allow the display 360 to remain in the ON state.

When the determination result indicates that the magnitude of the magnetic field is not less than a specified value, in operation 507, the processor 320 may measure a first time. The first time may be a time in which the magnitude of the magnetic field is maintained as being greater than or equal to the specified value. For example, in a state where the case device 10 is opened, when the user closes the case device 10, the magnitude of the magnetic field may increase gradually. The increased magnitude of the magnetic field may be maintained as being greater than or equal to the specified value during a specific time or more.

When the first time is measured, in operation 509, the processor 320 may compare the first time with the specified time. When the comparison result indicates that the first time is less than a specified time, the processor 320 may maintain the display 360 in the ON state. For example, when the user closes the case device 10 and then opens the case device 10, the processor 320 may maintain the display 360 in the ON state. Unlike the above-described embodiment, when the comparison result in operation 509 indicates that the first time is not less than the specified time, in operation 511, the processor 320 may turn off the display 360. For example, because there is no need to turn on the display 360 when a specific time elapses in a state where the case device 10 is closed, the processor 320 may turn off the display 360.

FIG. 5B illustrates an operation flowchart of the electronic device 100 including a case device in the case where the case device 10 is opened, when the display 360 is turned off, according to an embodiment.

Referring to FIG. 5B, in operation 551, the display 360 may be in an OFF state. For example, when the case device 10 is closed in operation 551, the processor 320 may turn off the display 360. When the display 360 is in the OFF state, the magnitude of a magnetic field may not be less than a specified value.

In operation 553, the integrated circuits 14-1 and 14-2 may generate a magnet-related signal. When the signal is generated, the integrated circuits 14-1 and 14-2 may transmit the signal to the processor 320 via the terminal 30. When the signal is transmitted to the processor 320, in operation 555, the processor 320 may determine whether the magnitude of the magnetic field is not less than a specified value. When the determination result indicates that the magnitude of the magnetic field is not less than the specified value, the processor 320 may allow the display 360 to remain in the OFF state. For example, when remaining in a state where the case device 10 is closed, the processor 320 may allow the display 360 to remain in the OFF state.

When the determination result indicates that the magnitude of the magnetic field is less than a specified value, in operation 557, the processor 320 may measure a second time. The second time may be a time in which the magnitude of the magnetic field is maintained as being less than the specified value. For example, in a state where the case device 10 is closed, when the user opens the case device 10, the magnitude of the magnetic field may decrease gradually. The decreased magnitude of the magnetic field may be maintained as being less than the specified value during a specific time or more.

When the second time is measured, in operation 559, the processor 320 may compare the second time with the specified time. When the comparison result indicates that the second time is less than a specified time, the processor 320 may maintain the display 360 in the OFF state. For example, when the user opens the case device 10 and then closes the case device 10 again, the processor 320 may maintain the display 360 in the OFF state. Unlike the above-described embodiment, when the comparison result in operation 559 indicates that the second time is not less than the specified time, in operation 561, the processor 320 may turn on the display 360. For example, because the electronic device 20 needs to be in a state where a user is capable of using the electronic device 20 when a specific time elapses in a state where the case device 10 is opened, the processor 320 may turn on the display 360.

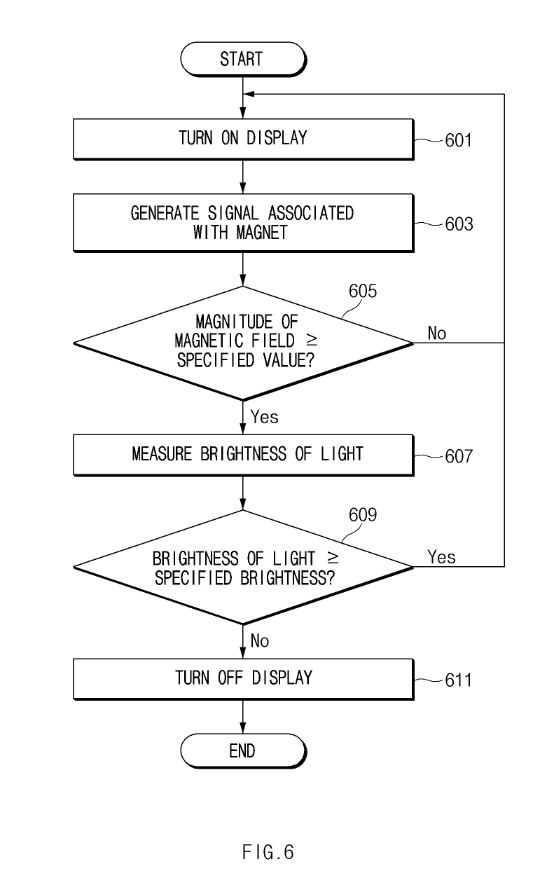

FIG. 6 illustrates an operation flowchart of the electronic device 100 including a case device that controls ON/OFF of the display 360, based on brightness of light input to the display 360, according to an embodiment.

Referring to FIG. 6, in operation 601, the display 360 may be in an ON state. For example, when the case device 10 is opened in operation 601, the processor 320 may turn on the display 360. When the display 360 is in the ON state, the magnitude of a magnetic field may be less than a specified value.

In operation 603, the integrated circuits 14-1 and 14-2 may generate a magnet-related signal. When the signal is generated, the integrated circuits 14-1 and 14-2 may transmit the signal to the processor 320 via the terminal 30. When the signal is transmitted to the processor 320, in operation 605, the processor 320 may determine whether the magnitude of the magnetic field is not less than a specified value. When the determination result indicates that the magnitude of the magnetic field is less than the specified value, the processor 320 may allow the display 360 to remain in the ON state. For example, when remaining in a state where the case device 10 is opened, the processor 320 may allow the display 360 to remain in the ON state.

When the determination result indicates that the magnitude of the magnetic field is not less than a specified value, in operation 607, the illuminance sensor 22 may measure (or detect) the brightness of light (or an illumination value) input via the illuminance sensor 22. Furthermore, in operation 607, a camera may measure the brightness of light input via the camera. When the brightness of light is measured, in operation 609, the processor 320 may compare the measured brightness of light with the specified brightness. According to an embodiment of the disclosure, the processor 320 may compare the brightness of light measured via the illuminance sensor 22 with specified brightness; alternatively, the processor 320 may compare the brightness of light measured via a camera with the specified brightness. Moreover, the processor 320 may compare the brightness of light measured via the illuminance sensor 22 and the camera with the specified brightness. For example, the processor 320 may compare the average value of the brightness of light measured via the illuminance sensor 22 and the camera with the specified brightness. The measured brightness of light may be changed based on whether the case device 10 is closed. For example, when the case device 10 is closed, the measured brightness of light may be dark; when the case device 10 is opened, the measured brightness of light may be bright.

When the comparison result between the measured brightness of light and the specified brightness indicates that the measured brightness of light is not less than the specified brightness, the processor 320 may maintain the display 360 in an ON state. When the comparison result between the measured brightness of light and the specified brightness indicates that the measured brightness of light is less than the specified brightness, in operation 611, the processor 320 may turn off the display 360. For example, when the user closes the case device 10, the brightness of light measured via the illuminance sensor 22 may be darker than the specified brightness. Furthermore, when the user closes the case device 10, the magnitude of the magnetic field may be greater than the specified value. Accordingly, when the magnitude of the magnetic field is greater than the specified value and the measured light is darker than the specified brightness, the processor 320 may determine that the case device 10 is closed, to turn off the display 360.

Unlike the embodiment illustrated in FIG. 6, when a state where the case device 10 is closed is changed to a state where the case device 10 is opened, the brightness of light may not be measured. For example, when the case device 10 is opened in a state where an external lighting is dark, the display 360 may be in an ON state. However, when ON/OFF of the display 360 is controlled based on the brightness of light in a state where an external lighting is dark, even though the case device 10 is opened, the display 360 may be turned off. Accordingly, when a state where the case device 10 is closed is changed to a state where the case device 10 is opened, the brightness of light may not be measured.

An embodiment is exemplified in FIG. 6 as the processor 320 controls ON/OFF of the display 360 based on the brightness of light. However, the processor 320 may control ON/OFF of the display 360 by using a timer. For example, when a state where the brightness of light is darker than the specified brightness and the magnitude of the magnetic field is not less than the specified value is maintained during a specific time or more, the processor 320 may turn off the display 360.

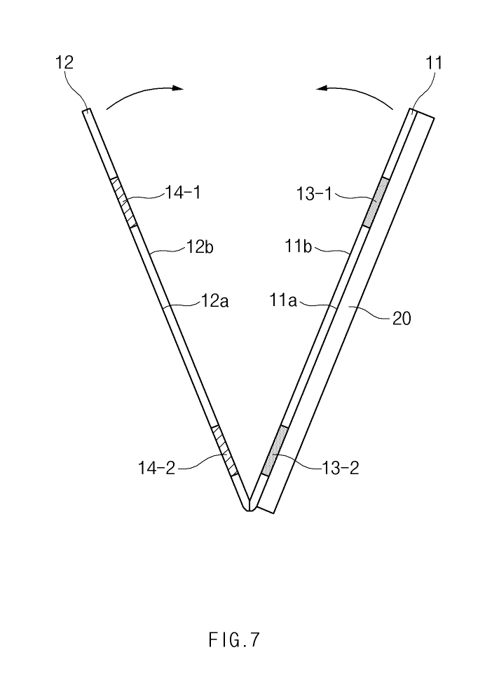

FIG. 7 illustrates the case device 10 that is folded such that the electronic device 20 is exposed to the outside, according to an embodiment.

Referring to FIG. 7, the first cover 11 may include a surface 11a and a surface 11b. The surface 11a may be a surface on which the electronic device 20 is disposed; the surface 11b may be a surface facing in a direction opposite to the surface 11a. The second cover 12 may include a surface 12a and a surface 12b. The surface 12a may be a surface that is in contact with the electronic device 20; the surface 12b may be a surface facing in a direction opposite to the surface 12b.

The processor 320 may control ON/OFF of the display 360 based on the direction of a magnetic field. For example, when the electronic device 20 is in contact with the surface 12a, the processor 320 may turn off the display 360. When the electronic device 20 is spaced apart from the surface 12a, the processor 320 may turn on the display 360. A procedure in which the processor 320 turns on/off the display 360 based on whether the electronic device 20 is in contact with the surface 12a may be substantially identical to the procedure described in FIGS. 5A and 5B.

Unlike the embodiment described above, when the surface 11b is in contact with the surface 12b, the processor 320 may turn on the display 360. For example, when the surface 11b is in contact with the surface 12b, the integrated circuits 14-1 and 14-2 may generate a signal indicating that the surface 11b is in contact with the surface 12b, through the direction of a magnetic field generated by the magnets 13-1 and 13-2. The signal may be different from a signal indicative of the direction of the magnetic field when the electronic device 20 is in contact with the surface 12a. For example, the direction of the magnetic field when the surface 11b is in contact with the surface 12b may be opposite to the direction of the magnetic field when the electronic device 20 is in contact with the surface 12a. Accordingly, the processor 320 may receive a signal indicating that the surface 11b is in contact with the surface 12b, via the terminal 30 to turn on the display 360.

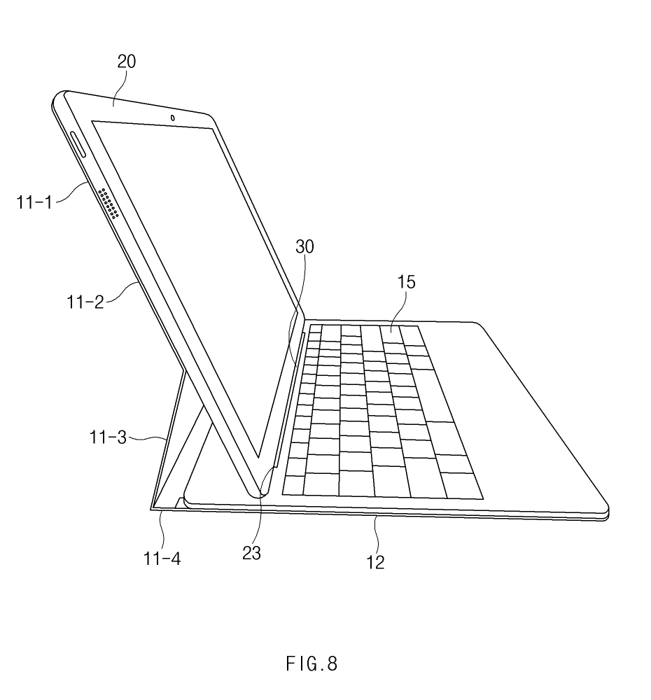

FIG. 8 is a view in which the edge 23 of the electronic device 20 is placed on the keyboard 15, according to an embodiment.

Referring to FIG. 8, the electronic device 20 may be disposed in at least one block of a plurality of blocks 11-1, 11-2, 11-3, and 11-4. For example, as illustrated in FIG. 8, the electronic device 20 may be disposed on the block 11-1 and the block 11-2 and may be spaced apart from the block 11-3 and the block 11-4. When the block 11-3 and the block 11-4 are spaced apart from the electronic device 20, the block 11-3 and the block 11-4 may function as a stand that fixes the electronic device 20.

According to an embodiment, the edge 23 of the electronic device 20 may be positioned on the surface of the second cover 12. For example, a recess capable of fixing the electronic device 20 by coupling the edge 23 of the electronic device 20 may be formed on the surface of the second cover 12. Unlike the above-described embodiment, the edge 23 of the electronic device 20 may be positioned on the surface of the keyboard 15. When the edge 23 of the electronic device 20 is positioned on the surface of the second cover 12 or the keyboard 15, the location of the terminal 30 may be positioned on the surface of the second cover 12 or the surface of the keyboard 15.

According to an embodiment of the disclosure, an electronic device may include at least one magnet, a display, a terminal receiving a signal associated with the at least one magnet from a case device, an illuminance sensor, and a processor. The processor may be configured to control ON/OFF of the display based on the signal transmitted from the terminal and brightness of light sensed by the illuminance sensor.

According to an embodiment of the disclosure, the signal may include information about magnitude of a magnetic field generated in the magnet, and the processor may be configured to turn off the display when the magnitude of the magnetic field is not less than a specified value and the brightness of the light is less than a specified brightness.

According to an embodiment of the disclosure, the processor may be configured to turn on a display, when the magnitude of the magnetic field is less than the specified value and the brightness of the light is not less than the specified brightness.

According to an embodiment of the disclosure, the signal may include information about a direction of a magnetic field generated in the magnet, and the processor may be configured to control ON/OFF of the display based on the direction of the magnetic field.

According to an embodiment of the disclosure, the processor may be configured to turn off a display based on a direction of a magnetic field generated when a first surface of the case device overlaps with the display and to turn on a display based on a direction of a magnetic field generated when a second surface of the case device overlaps with a rear housing of the electronic device.

According to an embodiment of the disclosure, the electronic device may further includes a camera, and the processor may be configured to control ON/OFF of the display based on the signal transmitted from the terminal, brightness of light sensed by the illuminance sensor, and brightness of light detected by the camera.

According to an embodiment of the disclosure, an electronic device including a case device may include at least one magnet, a first terminal receiving a signal associated with the magnet from the case device, a display, an illuminance sensor, and a processor. The case device may include an integrated circuit (IC) detecting a magnetic field generated by the at least one magnet and to generate the signal associated with the magnet and a second terminal electrically connected to the first terminal of the electronic device and transmitting the signal associated with the magnet from the case device to the electronic device. The processor of the electronic device may be configured to control ON/OFF of the display based on the signal associated with the magnet obtained via the first terminal and an illumination value sensed by the illuminance sensor.

According to an embodiment of the disclosure, the IC may be configured to generate a first signal when a magnitude of the magnetic field is not less than a first threshold value, and to generate a second signal when the magnitude of the magnetic field is less than a second threshold value that is less than or equal to the first threshold value.

According to an embodiment of the disclosure, the processor may be configured to turn off the display when the first signal is received and the illumination value is less than a specified brightness, and to turn on the display when the second signal is received and the illumination value is not less than the specified brightness.

According to an embodiment of the disclosure, the processor may be configured to turn on the display when the second signal is received.

According to an embodiment of the disclosure, the signal associated with the magnet may include information about a magnitude and a direction of the magnetic field, and the processor may be configured to control ON/OFF of the display, based on the magnitude and the direction of the magnetic field.

According to an embodiment of the disclosure, when the electronic device overlaps with the case device, the IC may be disposed at a location corresponding to the magnet.

According to an embodiment of the disclosure, the case device may further include a keyboard.

According to an embodiment of the disclosure, the processor may be configured to receive data input from the keyboard via the terminal to output the data to the display.

According to an embodiment of the disclosure, a case device may include a first cover, a second cover at least partly overlapping with the first cover, a magnet disposed on the first cover, and an IC disposed on the second cover and configured to transmit a signal associated with the magnet to a tablet device.

According to an embodiment of the disclosure, the case device may further include a terminal electrically connecting the case device to the tablet device, and the IC is configured to transmit the signal to the tablet device via the terminal.

According to an embodiment of the disclosure, the integrated circuit may be a Hall IC and the terminal may be a POGO terminal.

According to an embodiment of the disclosure, when the first cover overlaps with the second cover, the IC may be disposed at a location corresponding to the magnet.

According to an embodiment of the disclosure, a first cover may be divided into a plurality of blocks, and the magnet may be disposed in one of the plurality of blocks.

According to an embodiment of the disclosure, the integrated circuit is configured to transmit a first signal to the tablet device when the magnitude of a magnetic field generated by the magnet is not less than a specified value, and to transmit a second signal to the tablet device when the magnitude of a magnetic field is less than the specified value.

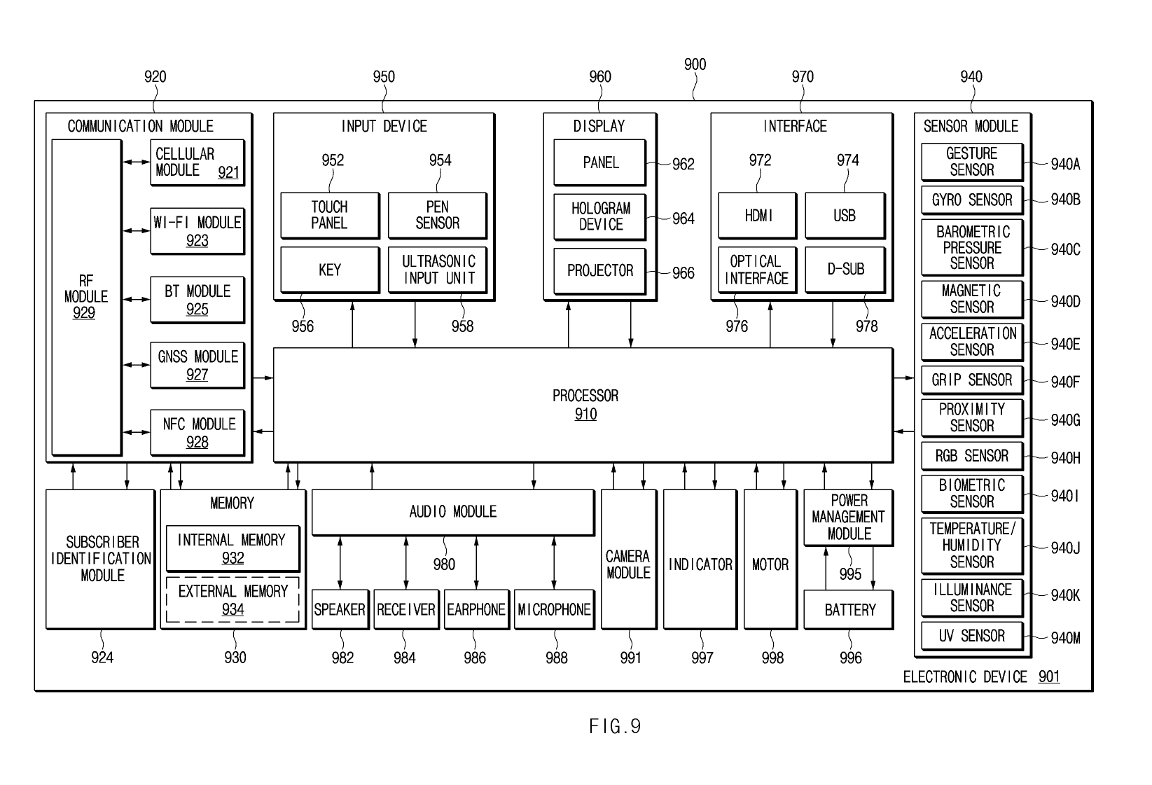

FIG. 9 illustrates a block diagram of an electronic device, according to an embodiment.

Referring to FIG. 9, an electronic device 901 may include, for example, all or a part of the electronic device 301 illustrated in FIG. 3. The electronic device 901 may include one or more processors (e.g., an application processor (AP)) 910, a communication module 920, a subscriber identification module 924, a memory 930, a sensor module 940, an input device 950, a display 960, an interface 970, an audio module 980, a camera module 991, a power management module 995, a battery 996, an indicator 997, and a motor 998.

The processor 910 may drive, for example, an operating system (OS) or an application to control a plurality of hardware or software components connected to the processor 910 and may process and compute a variety of data. For example, the processor 910 may be implemented with a System on Chip (SoC). According to an embodiment, the processor 910 may further include a graphic processing unit (GPU) and/or an image signal processor. The processor 910 may include at least a part (e.g., a cellular module 921) of components illustrated in FIG. 9. The processor 910 may load a command or data, which is received from at least one of other components (e.g., a nonvolatile memory), into a volatile memory and process the loaded command or data. The processor 910 may store a variety of data in the nonvolatile memory.

The communication module 920 may be configured the same as or similar to the communication interface 370 of FIG. 3. The communication module 920 may include the cellular module 921, a Wi-Fi module 922, a Bluetooth (BT) module 923, a GNSS module 924 (e.g., a GPS module, a Glonass module, a Beidou module, or a Galileo module), a near field communication (NFC) module 925, a MST module 926 and a radio frequency (RF) module 927.

The cellular module 921 may provide, for example, voice communication, video communication, a character service, an Internet service, or the like over a communication network. According to an embodiment, the cellular module 921 may perform discrimination and authentication of the electronic device 901 within a communication network by using the subscriber identification module (e.g., a SIM card) 929. According to an embodiment, the cellular module 921 may perform at least a portion of functions that the processor 910 provides. According to an embodiment, the cellular module 921 may include a communication processor (CP).

Each of the Wi-Fi module 922, the BT module 923, the GNSS module 924, the NFC module 925, or the MST module 926 may include a processor for processing data exchanged through a corresponding module, for example.

According to an embodiment, at least a part (e.g., two or more) of the cellular module 921, the Wi-Fi module 922, the BT module 923, the GNSS module 924, the NFC module 925, or the MST module 926 may be included within one Integrated Circuit (IC) or an IC package.

For example, the RF module 927 may transmit and receive a communication signal (e.g., an RF signal). For example, the RF module 927 may include a transceiver, a power amplifier module (PAM), a frequency filter, a low noise amplifier (LNA), an antenna, or the like. According to another embodiment, at least one of the cellular module 921, the Wi-Fi module 922, the BT module 923, the GNSS module 924, the NFC module 925, or the MST module 926 may transmit and receive an RF signal through a separate RF module.

The subscriber identification module 929 may include, for example, a card and/or embedded SIM that includes a subscriber identification module and may include unique identify information (e.g., integrated circuit card identifier (ICCID)) or subscriber information (e.g., international mobile subscriber identity (IMSI)).

The memory 930 (e.g., the memory 330) may include an internal memory 932 or an external memory 934. For example, the internal memory 932 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 934 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 934 may be operatively and/or physically connected to the electronic device 901 through various interfaces.

A security module 936 may be a module that includes a storage space of which a security level is higher than that of the memory 930 and may be a circuit that guarantees safe data storage and a protected execution environment. The security module 936 may be implemented with a separate circuit and may include a separate processor. For example, the security module 936 may be in a smart chip or a secure digital (SD) card, which is removable, or may include an embedded secure element (eSE) embedded in a fixed chip of the electronic device 901. Furthermore, the security module 936 may operate based on an operating system (OS) that is different from the OS of the electronic device 901. For example, the security module 936 may operate based on java card open platform (JCOP) OS.

The sensor module 940 may measure, for example, a physical quantity or may detect an operation state of the electronic device 901. The sensor module 940 may convert the measured or detected information to an electric signal. For example, the sensor module 940 may include at least one of a gesture sensor 940A, a gyro sensor 940B, a barometric pressure sensor 940C, a magnetic sensor 940D, an acceleration sensor 940E, a grip sensor 940F, the proximity sensor 940G, a color sensor 940H (e.g., red, green, blue (RGB) sensor), a biometric sensor 940I, a temperature/humidity sensor 940J, an illuminance sensor 940K, or an UV sensor 940M. Although not illustrated, additionally or alternatively, the sensor module 940 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 940 may further include a control circuit for controlling at least one or more sensors included therein. According to an embodiment, the electronic device 901 may further include a processor that is a part of the processor 910 or independent of the processor 910 and is configured to control the sensor module 940. The processor may control the sensor module 940 while the processor 910 remains at a sleep state.

The input device 950 may include, for example, a touch panel 952, a (digital) pen sensor 954, a key 956, or an ultrasonic input unit 958. For example, the touch panel 952 may use at least one of capacitive, resistive, infrared and ultrasonic detecting methods. Also, the touch panel 952 may further include a control circuit. The touch panel 952 may further include a tactile layer to provide a tactile reaction to a user.

The (digital) pen sensor 954 may be, for example, a part of a touch panel or may include an additional sheet for recognition. The key 956 may include, for example, a physical button, an optical key, a keypad, or the like. The ultrasonic input device 958 may detect (or sense) an ultrasonic signal, which is generated from an input device, through a microphone (e.g., a microphone 988) and may check data corresponding to the detected ultrasonic signal. According to an embodiment, the touch panel 9352 may include a pressure sensor (or force sensor, interchangeably used hereinafter) that measures the intensity of touch pressure by a user. The pressure sensor may be implemented integrally with the touch panel 952, or may be implemented as at least one sensor separately from the touch panel 952.

The display 960 (e.g., the display 960) may include a panel 962, a hologram device 964, or a projector 966. The panel 962 may be the same as or similar to the display 360 illustrated in FIG. 3. The panel 962 may be implemented, for example, to be flexible, transparent or wearable. The panel 962 and the touch panel 952 may be integrated into a single module. The hologram device 964 may display a stereoscopic image in a space using a light interference phenomenon. The projector 966 may project light onto a screen so as to display an image. For example, the screen may be arranged in the inside or the outside of the electronic device 901. According to an embodiment, the display 960 may further include a control circuit for controlling the panel 962, the hologram device 964, or the projector 966.

The interface 970 may include, for example, a high-definition multimedia interface (HDMI) 972, a universal serial bus (USB) 974, an optical interface 976, or a D-subminiature (D-sub) 978. The interface 970 may be included, for example, in the communication interface 370 illustrated in FIG. 3. Additionally or alternatively, the interface 970 may include, for example, a mobile high definition link (MHL) interface, a SD card/multi-media card (MMC) interface, or an infrared data association (IrDA) standard interface.

The audio module 980 may convert a sound and an electric signal in dual directions. At least a component of the audio module 980 may be included, for example, in the input/output interface 350 illustrated in FIG. 3. The audio module 980 may process, for example, sound information that is input or output through a speaker 982, a receiver 984, an earphone 986, or the microphone 988.

For example, the camera module 991 may shoot a still image or a video. According to an embodiment, the camera module 991 may include at least one or more image sensors (e.g., a front sensor or a rear sensor), a lens, an image signal processor (ISP), or a flash (e.g., an LED or a xenon lamp).

The power management module 995 may manage, for example, power of the electronic device 901. According to an embodiment, a power management integrated circuit (PMIC), a charger IC, or a battery or fuel gauge may be included in the power management module 995. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 996 and a voltage, current or temperature thereof while the battery is charged. The battery 996 may include, for example, a rechargeable battery and/or a solar battery.

The indicator 997 may display a specific state of the electronic device 901 or a part thereof (e.g., the processor 910), such as a booting state, a message state, a charging state, and the like. The motor 998 may convert an electrical signal into a mechanical vibration and may generate the following effects: vibration, haptic, and the like. Although not illustrated, a processing device (e.g., a GPU) for supporting a mobile TV may be included in the electronic device 901. The processing device for supporting the mobile TV may process media data according to the standards of digital multimedia broadcasting (DMB), digital video broadcasting (DVB), MediaFlo™, or the like.

Each of the above-mentioned components of the electronic device according to various embodiments of the disclosure may be configured with one or more parts, and the names of the components may be changed according to the type of the electronic device. In various embodiments, the electronic device may include at least one of the above-mentioned components, and some components may be omitted or other additional components may be added. Furthermore, some of the components of the electronic device according to various embodiments may be combined with each other so as to form one entity, so that the functions of the components may be performed in the same manner as before the combination.

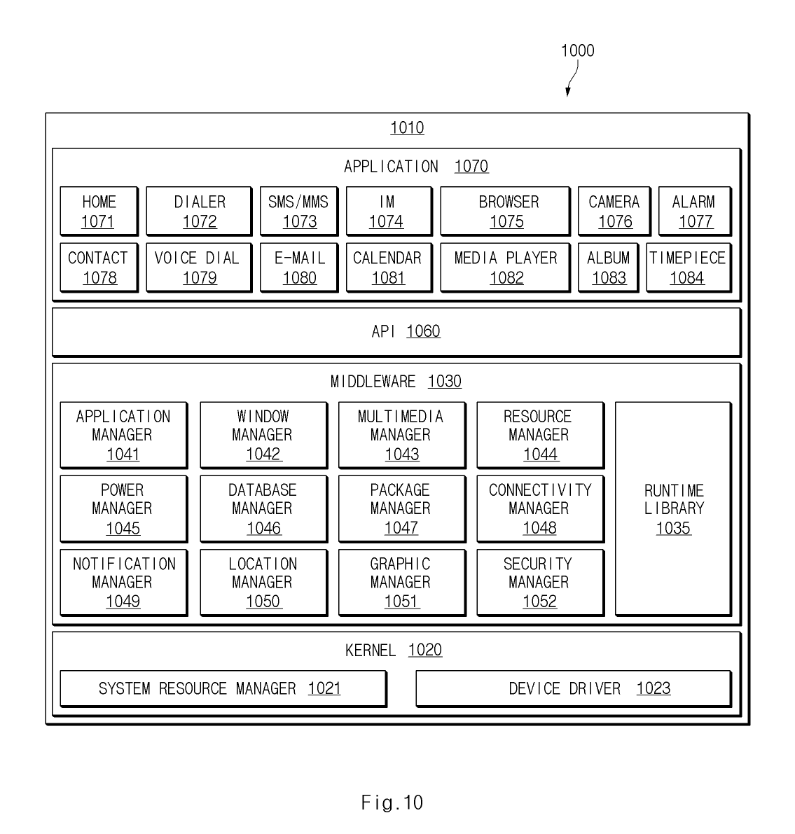

FIG. 10 illustrates a block diagram of a program module, according to various embodiments.

According to an embodiment, a program module 1010 (e.g., the program 340) may include an operating system (OS) to control resources associated with an electronic device (e.g., the electronic device 301), and/or diverse applications (e.g., the application program 347) driven on the OS. The OS may be, for example, Android™, iOS™, Windows™, Symbian™, or Tizen™.

The program module 1010 may include a kernel 1020, a middleware 1030, an application programming interface (API) 1060, and/or an application 1070. At least a portion of the program module 1010 may be preloaded on an electronic device or may be downloadable from an external electronic device (e.g., the first electronic device 302, the second electronic device 304, the server 306, or the like).

The kernel 1020 (e.g., the kernel 341) may include, for example, a system resource manager 1021 or a device driver 1023. The system resource manager 1021 may perform control, allocation, or retrieval of system resources. According to an embodiment, the system resource manager 1021 may include a process managing unit, a memory managing unit, or a file system managing unit. The device driver 1023 may include, for example, a display driver, a camera driver, a Bluetooth driver, a shared memory driver, a USB driver, a keypad driver, a Wi-Fi driver, an audio driver, or an inter-process communication (IPC) driver.

The middleware 1030 may provide, for example, a function that the application 1070 needs in common, or may provide diverse functions to the application 1070 through the API 1060 to allow the application 1070 to efficiently use limited system resources of the electronic device. According to an embodiment, the middleware 1030 (e.g., the middleware 343) may include at least one of a runtime library 1035, an application manager 1041, a window manager 1042, a multimedia manager 1043, a resource manager 1044, a power manager 1045, a database manager 1046, a package manager 1047, a connectivity manager 1048, a notification manager 1049, a location manager 1050, a graphic manager 1051, a security manager 1052, or a payment manager 1054.

The runtime library 1035 may include, for example, a library module that is used by a compiler to add a new function through a programming language while the application 1070 is being executed. The runtime library 1035 may perform input/output management, memory management, or capacities about arithmetic functions.

The application manager 1041 may manage, for example, a life cycle of at least one application of the application 1070. The window manager 1042 may manage a graphic user interface (GUI) resource that is used in a screen. The multimedia manager 1043 may identify a format necessary for playing diverse media files, and may perform encoding or decoding of media files by using a codec suitable for the format. The resource manager 1044 may manage resources such as a storage space, memory, or source code of at least one application of the application 1070.

The power manager 1045 may operate, for example, with a basic input/output system (BIOS) to manage a battery or power, and may provide power information for an operation of an electronic device. The database manager 1046 may generate, search for, or modify database that is to be used in at least one application of the application 1070. The package manager 1047 may install or update an application that is distributed in the form of package file.

The connectivity manager 1048 may manage, for example, wireless connection such as Wi-Fi or Bluetooth. The notification manager 1049 may display or notify an event such as arrival message, appointment, or proximity notification in a mode that does not disturb a user. The location manager 1050 may manage location information about an electronic device. The graphic manager 1051 may manage a graphic effect that is provided to a user, or manage a user interface relevant thereto. The security manager 1052 may provide a general security function necessary for system security, user authentication, or the like. According to an embodiment, in the case where an electronic device (e.g., the electronic device 301) includes a telephony function, the middleware 1030 may further include a telephony manager for managing a voice or video call function of the electronic device.

The middleware 1030 may include a middleware module that combines diverse functions of the above-described components. The middleware 1030 may provide a module specialized to each OS kind to provide differentiated functions. Additionally, the middleware 1030 may dynamically remove a part of the preexisting components or may add new components thereto.

The API 1060 (e.g., the API 345) may be, for example, a set of programming functions and may be provided with a configuration that is variable depending on an OS. For example, in the case where an OS is Android™ or iOS™, it may provide one API set per platform. In the case where an OS is Tizen™, it may provide two or more API sets per platform.

The application 1070 (e.g., the application program 347) may include, for example, one or more applications capable of providing functions for a home 1071, a dialer 1072, an SMS/MMS 1073, an instant message (IM) 1074, a browser 1075, a camera 1076, an alarm 1077, a contact 1078, a voice dial 1079, an e-mail 1080, a calendar 1081, a media player 1082, an album 1083, and a timepiece 1084, or for offering health care (e.g., measuring an exercise quantity, blood sugar, or the like) or environment information (e.g., information of barometric pressure, humidity, temperature, or the like).

According to an embodiment, the application 1070 may include an application (hereinafter referred to as “information exchanging application” for descriptive convenience) to support information exchange between an electronic device (e.g., the electronic device 301) and an external electronic device (e.g., the first electronic device 302 or the second electronic device 304). The information exchanging application may include, for example, a notification relay application for transmitting specific information to an external electronic device, or a device management application for managing the external electronic device.

For example, the notification relay application may include a function of transmitting notification information, which arise from other applications (e.g., applications for SMS/MMS, e-mail, health care, or environmental information), to an external electronic device. Additionally, the notification relay application may receive, for example, notification information from an external electronic device and provide the notification information to a user.

The device management application may manage (e.g., install, delete, or update), for example, at least one function (e.g., turn-on/turn-off of an external electronic device itself (or a part) or adjustment of brightness (or resolution) of a display) of the external electronic device which communicates with the electronic device, an application running in the external electronic device, or a service (e.g., a call service, a message service, or the like) provided from the external electronic device.

According to an embodiment, the application 1070 may include an application (e.g., a health care application of a mobile medical device) that is assigned in accordance with an attribute of an external electronic device. According to an embodiment, the application 1070 may include an application that is received from an external electronic device (e.g., the first electronic device 302, the second electronic device 304, or the server 306). According to an embodiment, the application 1070 may include a preloaded application or a third party application that is downloadable from a server. The names of components of the program module 1010 according to the embodiment may be modifiable depending on kinds of operating systems.

According to various embodiments, at least a portion of the program module 1010 may be implemented by software, firmware, hardware, or a combination of two or more thereof. At least a portion of the program module 1010 may be implemented (e.g., executed), for example, by the processor (e.g., the processor 910). At least a portion of the program module 1010 may include, for example, modules, programs, routines, sets of instructions, processes, or the like for performing one or more functions.

The term “module” used in the disclosure may represent, for example, a unit including one or more combinations of hardware, software and firmware. The term “module” may be interchangeably used with the terms “unit”, “logic”, “logical block”, “part” and “circuit”. The “module” may be a minimum unit of an integrated part or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 320), may cause the one or more processors to perform a function corresponding to the instruction. The computer-readable storage media, for example, may be the memory 330.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, the one or more instructions may contain a code made by a compiler or a code executable by an interpreter. The above hardware unit may be configured to operate via one or more software modules for performing an operation according to various embodiments, and vice versa.

A module or a program module according to various embodiments may include at least one of the above components, or a part of the above components may be omitted, or additional other components may be further included. Operations performed by a module, a program module, or other components according to various embodiments may be executed sequentially, in parallel, repeatedly, or in a heuristic method. In addition, some operations may be executed in different sequences or may be omitted. Alternatively, other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
at least one magnet;
a display;
a terminal configured to receive a signal associated with the at least one magnet from a case device;
an illuminance sensor, and
a processor,
wherein the processor is configured to:
control ON/OFF of the display based on the signal transmitted from the terminal and brightness of light sensed by the illuminance sensor.

2. The electronic device of claim 1, wherein the signal includes information about magnitude of a magnetic field generated in the magnet, and
wherein the processor is configured to:
when the magnitude of the magnetic field is not less than a specified value and the brightness of the light is less than a specified brightness, turn off the display.

3. The electronic device of claim 2, wherein the processor is configured to:
when the magnitude of the magnetic field is less than the specified value and the brightness of the light is not less than the specified brightness, turn on the display.

4. The electronic device of claim 1, wherein the signal includes information about a direction of a magnetic field generated in the magnet, and
wherein the processor is configured to:
control ON/OFF of the display based on the direction of the magnetic field.

5. The electronic device of claim 4, wherein the processor is configured to:
turn off the display based on a direction of a magnetic field generated when a first surface of the case device overlaps with the display; and
turn on the display based on a direction of a magnetic field generated when a second surface of the case device overlaps with a rear housing of the electronic device.

6. The electronic device of claim 1, wherein the electronic device further includes a camera, and
wherein the processor is configured to:
control ON/OFF of the display based on the signal transmitted from the terminal, the brightness of light sensed by the illuminance sensor, and brightness of light detected by the camera.

7. An electronic device including a case device, the electronic device comprising:
at least one magnet;
a first terminal configured to receive a signal associated with the magnet from the case device;
a display;
an illuminance sensor; and
a processor,
wherein the case device includes:
an integrated circuit (IC) configured to detect a magnetic field generated by the at least one magnet and to generate the signal associated with the magnet; and
a second terminal electrically connected to the first terminal of the electronic device and configured to transmit the signal associated with the magnet from the case device to the electronic device, and
wherein the processor of the electronic device is configured to:
control ON/OFF of the display based on the signal associated with the magnet obtained via the first terminal and an illumination value sensed by the illuminance sensor.

8. The electronic device of claim 7, wherein the IC is configured to:
when a magnitude of the magnetic field is not less than a first threshold value, generate a first signal; and
when the magnitude of the magnetic field is less than a second threshold value that is less than or equal to the first threshold value, generate a second signal.

9. The electronic device of claim 8, wherein the processor is configured to:
when the first signal is received and the illumination value is less than a specified brightness, turn off the display; and
when the second signal is received and the illumination value is not less than the specified brightness, turn on the display.

10. The electronic device of claim 7, wherein the signal associated with the magnet includes information about a magnitude and a direction of the magnetic field, and
wherein the processor is configured to:
control ON/OFF of the display, based on the magnitude and the direction of the magnetic field.

11. The electronic device of claim 7, wherein the IC is disposed at a location corresponding to the magnet, when the electronic device overlaps with the case device.

12. A case device comprising:
a first cover;
a second cover at least partly overlapping with the first cover;
a magnet disposed on the first cover; and
an IC disposed on the second cover and configured to transmit a signal associated with the magnet to a tablet device.

13. The case device of claim 12, wherein the case device further includes:
a terminal electrically connecting the case device to the tablet device, and
wherein the IC is configured to:
transmit the signal to the tablet device via the terminal.

14. The case device of claim 12, wherein the IC is disposed at a location corresponding to the magnet, when the first cover overlaps with the second cover.

15. The case device of claim 12, wherein the first cover is divided into a plurality of blocks, and
wherein the magnet is disposed in one of the plurality of blocks.
